(19) United States
(12) Patent Application Publication
(10) Pub. No.: US 2023/0351105 A1
(43) Pub. Date: Nov. 2, 2023

(54) SYSTEMS AND METHODS FOR ENHANCED DOCUMENT GENERATION

(71) Applicant: Leverage Technologies, LLC, Berkeley, CA (US)

(72) Inventor: Chris Mammen, Berkeley, CA (US)

(21) Appl. No.: 18/299,463

(22) Filed: Apr. 12, 2023

Related U.S. Application Data
(60) Provisional application No. 63/363,900, filed on Apr. 29, 2022.

(51) Int. Cl. G06F 40/186; G06Q 50/18; G06F 21/62

(52) U.S. Cl. CPC G06F 40/186; G06Q 50/18; G06F 21/6245

(57) ABSTRACT

Systems, apparatuses, methods, and computer program products are disclosed for enhanced document generation. An example method includes receiving, by an apparatus, a document comprising a set of requests for production (RFPs), and extracting, by the apparatus, the set of RFPs from the document to provide a number of separate requests. The example method further includes generating and/or receiving, by the apparatus, a response catalog defining a set of template objections and responses; interactively preparing, by the apparatus, a set of objections and responses using the set of set of RFPs and the response catalog; and generating, by the apparatus, a formatted document including the set of objections and responses, the formatted document comprising a set of responses to the set of RFPs. The example method may further include outputting, by the apparatus, the formatted document. Corresponding apparatuses and computer program products may also be provided.

### CROSS-REFERNCE TO RELATED APPLICATIONS

This application claims priority from U.S. Provisional Application No. 63/363,900 filed Apr. 29, 2022, the entirety of which is incorporated herein by reference.

### BACKGROUND

In litigation, the term “discovery” refers to the formal process of exchanging information between parties in preparation for trial. Part of this process is typically performed via formal written requests for discovery, including interrogatories, requests for admission, subpoenas, and requests for production of documents and responses thereto. Responding to written discovery, including requests for production, is time-consuming, tedious, and subject to rigorous best-practices expectations. While the following disclosure focuses primarily on requests for production as an illustrative embodiment, it will be appreciated that the inventions disclosed and claimed herein may be readily implemented and applied to other forms of written discovery and other litigation documents as well.

### BRIEF SUMMARY

Discovery costs can account for a significant proportion (according to some, up to half) of the cost of litigation, and written discovery responses represent a major portion of this overall expense. Some discovery costs are unavoidable, but other costs are the product of the laborious procedures that have historically been deployed, leading to significant pain points for those responsible for drafting written discovery responses.

Several of these pain points are as follow. Responding to requests for production (RFPs) can be tedious, because documents containing RFPs can typically include tens or hundreds of separately enumerated requests, and objections must be customized for each request. On the one hand, any objections not included in a specific response are considered waived; on the other hand, if each response includes an indiscriminately broad repetition of all theoretically possible objections, the objections may also be deemed waived as not being tailored to the specific request. Accordingly, responding to a set of RFPs is a repetitive process, with much overlapping, similar (but not identical) work. Because separate requests may be similar but not identical, one cannot simply cut-and-paste responses, and avoiding internal inconsistency requires careful legal judgment and attention. Furthermore, revisions or updates to RFP responses can involve dozens of similar or identical changes that may resist automation due to text length, context, or other factors that make traditional text-editing tools unsuitable.

Moreover, existing technologies (e.g., technologies in the technical fields of document automation and/or automated document generation) for responding to written discovery, including RFPs, are inadequate. Typical automated document assembly tools available on the market have typically been directed to the problems of automated contract assembly or similar tasks, and fail to support the iterative, repetitive and semi-customized drafting process required for responding to sets of RFPs. At the same time, AI-based tools, including large language model-based generative AI systems, are not yet sophisticated enough to fully replace trained lawyers' judgment. The inventor has therefore identified a long-felt but unsolved need for better solutions that can significantly reduce the time (and, by extension, cost) required to draft an appropriate set of objections and responses to a set of RFPs, while simultaneously permitting an efficient exercise of trained legal judgment. Example embodiments described herein eliminate the tedium of repetitive work, but also reduce both the risk of error from drafting and revising responses to sets of RFPs and the consumption of time spent performing those repetitive tasks. In particular, the inventor has observed a two-thirds reduction in drafting time when example embodiments described herein are used by experienced legal professionals (e.g., partners, senior associates, or the like) to produce responses to a set of RFPs, which far exceeds the inventor's initial time reduction expectations. Additionally, example embodiments described herein provide these benefits while also preserving lawyer judgment in the selection and framing of objections. Still further, example embodiments enable use of a checklist-based approach that improves quality, while also training junior lawyers to learn best practices in discovery. As a result, example embodiments described herein not only provide a computerized solution to a computerized problem (e.g., the inadequacies of existing document automation and/or automated document generation technologies) but also provide a direct improvement to the technical fields of document automation and/or automated document generation.

Systems, apparatuses, methods, and computer program products are disclosed herein for enhanced document generation, and more specifically for enhanced generation of responses to a set of RFPs.

In a first example embodiment, a method is provided for automated enhanced document generation (e.g., during a discovery period during litigation (also referred to herein as “a litigation discovery period”)). The method includes receiving, by an apparatus, a document comprising a set of RFPs, and extracting, by the apparatus and from the document, a number of separate, individual requests collectively comprising the set of RFPs. Extraction of the set of RFPs from the document involves (i) parsing the document into discrete components, (ii) identifying characteristics in the discrete components known to indicate the beginning or end of individual RFPs, (iii) detecting the separate, individual requests within the document based on the identified characteristics, and (iv) extracting these separate, individual requests as the set of RFPs. The method further includes receiving, by the apparatus, a response catalog defining a collection of template objections and responses to discovery requests (including a label, full text, and any variable text fields for each such objection and response), interactively preparing, by the apparatus, a set of objections and responses to the set of RFPs using the number of separate requests and the response catalog; and generating, by the apparatus, a formatted document including the set of objections and responses, the formatted document comprising responses to the set of RFPs. The method may further include outputting, by the apparatus, the formatted document.

In another example embodiment, an apparatus is provided for automated enhanced document generation. The apparatus may include a processor and a memory storing software instructions that, when executed by the processor, cause the apparatus to perform the steps recited above.

In yet another example embodiment, a computer program product is provided for automated enhanced document generation. The computer program product includes at least one non-transitory computer-readable storage medium storing software instructions that, when executed, cause an apparatus to cause an apparatus to perform the steps recited above.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a schematic block diagram of example circuitry embodying a device that may perform various operations in accordance with example embodiments described herein.

FIG. 2 illustrates an example flowchart for enhanced document generation, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

### Overview

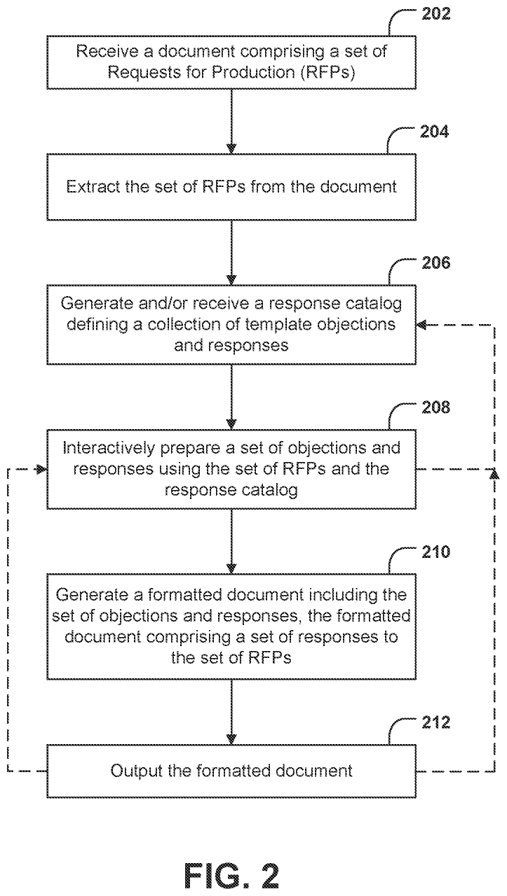

As noted above, methods, apparatuses, systems, and computer program products are described herein that provide for enhanced document generation and, more specifically, enhanced generation of responses to RFPs during discovery. At a high level, example embodiments involve the management of a list of cases regarding which RFPs may be received. Such example embodiments further involve receiving a set of RFPs as a document in a standard format such as Word or PDF (including any attendant optical character recognition or other necessary pre-processing), extracting a number of RFPs from the document, maintaining (including storing, creating and/or receiving) a catalog of objections and responses to discovery requests (including without limitation standard, specialized, or frequently used objections and responses), and then interactive preparation and formatting of objections and responses in response to the individual RFPs in the set of RFPs. Such examples thereafter generate formatted documents from the interactively prepared objections and responses, and facilitate iterative revision and re-generation of revised formatted documents as-needed. Greater detail regarding specifics of example implementations is provided below in connection with the description of FIG. 2.

Some advantages of embodiments set forth herein include the elimination of tedious, non-economical and repetitive work, and the reduction in both the risk of error from drafting and revising responses to RFPs, and reductions in the consumption of time spent performing those repetitive tasks. Moreover, additional advantages of the embodiments described herein include providing these benefits while also preserving the exercise of lawyer judgment deployed in the selection and framing of objections, and enabling and facilitating the use of a checklist-based approach that improves quality. Moreover, the computer-implemented approach set forth herein produces high quality responses to RFPs in a manner that does not simply automate historically manual activity, but that employs a wholly distinct mechanism of operation leveraging computer technology to save time, limit resource utilization, improve quality of work product, and thereby provide the other benefits noted above. As a result, example embodiments described herein not only provide a computerized solution to a computerized problem (e.g., the inadequacies of existing document automation and/or automated document generation technologies) but also provide a direct improvement to the technical fields of document automation and/or automated document generation.

Although a high-level explanation of the operations of example embodiments has been provided above, specific details regarding the configuration of such example embodiments are provided below.

### EXAMPLE IMPLEMENTING APPARATUSES

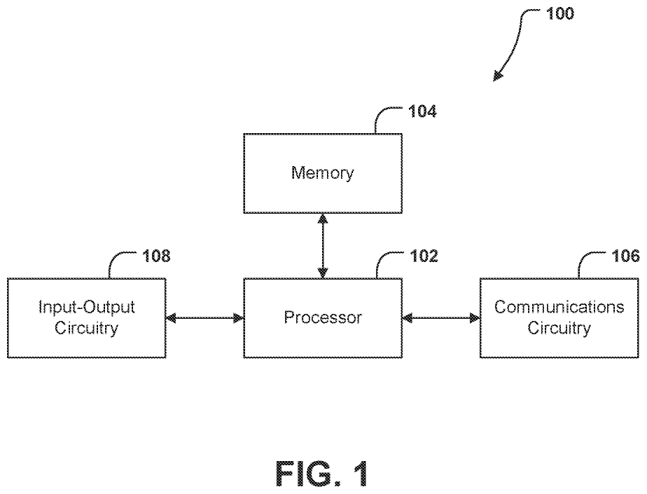

FIG. 1 illustrates an example apparatus 100 that may implement example embodiments described herein. The apparatus 100 may include processor 102, memory 104, communications circuitry 106, and input-output circuitry 108, each of which will be described in greater detail below, along with and any number of additional hardware components not expressly shown in FIG. 1. While the various components are only illustrated in FIG. 1 as being connected with processor 102, it will be understood that the apparatus 100 may further comprise a bus (not expressly shown in FIG. 1) for passing information amongst any combination of the various components of the apparatus 100. The apparatus 100 may be configured to execute various operations described below in connection with FIGS. 1 and 2. It will be understood that while a single apparatus 100 may be configured to execute these operations, some implementations may involve multiple apparatuses 100 that respectively execute subsets of these operations. In such implementations, the multiple apparatuses 100 need only include the components shown in connection with apparatus 100 required to execute the operations that they respectively perform.

The processor 102 (and/or co-processor or any other processor assisting or otherwise associated with the processor) may be in communication with the memory 104 via a bus for passing information amongst components of the apparatus. The processor 102 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 100, remote or “cloud” processors, or any combination thereof

The processor 102 may be configured to execute software instructions stored in the memory 104 or otherwise accessible to the processor (e.g., software instructions stored on a separate storage device). In some cases, the processor may be configured to execute hard-coded functionality. As such, whether configured by hardware or software methods, or by a combination of hardware with software, the processor 102 represent an entity (e.g., physically embodied in circuitry) capable of performing operations according to various embodiments of the present invention while configured accordingly. Alternatively, as another example, when the processor 102 is embodied as an executor of software instructions, the software instructions may specifically configure the processor 102 to perform the algorithms and/or operations described herein when the software instructions are executed.

Memory 104 is non-transitory and may include, for example, one or more volatile and/or non-volatile memories. In other words, for example, the memory 104 may be an electronic storage device (e.g., a computer readable storage medium). The memory 104 may be configured to store information, data, content, applications, software instructions, or the like, for enabling the apparatus to carry out various functions in accordance with example embodiments contemplated herein.

The communications circuitry 106 may be any means such as a device or circuitry embodied in either hardware or a combination of hardware and software that is configured to receive and/or transmit data from/to a network and/or any other device, circuitry, or module in communication with the apparatus 100. In this regard, the communications circuitry 106 may include, for example, a network interface for enabling communications with a wired or wireless communication network. For example, the communications circuitry 106 may include one or more network interface cards, antennas, buses, switches, routers, modems, and supporting hardware and/or software, or any other device suitable for enabling communications via a network. Furthermore, the communications circuitry 106 may include the processing circuitry for causing transmission of such signals to a network or for handling receipt of signals received from a network.

The apparatus 100 may include input-output circuitry 108 configured to provide output to a user and, in some embodiments, to receive an indication of user input. It will be noted that some embodiments will not include input-output circuitry 108, in which case user input may be received via a separate device. The input-output circuitry 108 may comprise a user interface, such as a display, and may further comprise the components that govern use of the user interface, such as a web browser, mobile application, dedicated client device, or the like. In some embodiments, the input-output circuitry 108 may include a keyboard, a mouse, a touch screen, touch areas, soft keys, a microphone, a speaker, and/or other input/output mechanisms. The input-output circuitry 108 may utilize the processor 102 to control one or more functions of one or more of these user interface elements through software instructions (e.g., application software and/or system software, such as firmware) stored on a memory (e.g., memory 104) accessible to the processor 102.

In some embodiments, various components of the apparatus 100 may be hosted remotely (e.g., by one or more cloud servers) and thus not all components must reside in one physical location. Moreover, some of the functionality described herein may be provided by third party circuitry. For example, apparatus 100 may access one or more third party circuitries via any sort of networked connection that facilitates transmission of data and electronic information between the apparatus 100 and the third party circuitries. In turn, the apparatus 100 may be in remote communication with one or more of the components describe above as comprising the apparatus 100.

As will be appreciated based on this disclosure, some example embodiments may take the form of a computer program product comprising software instructions stored on at least one non-transitory computer-readable storage medium (e.g., memory 104). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 100 as described in FIG. 1, that loading the software instructions onto a computing device or apparatus produces a special-purpose machine comprising the means for implementing various functions described herein.

Having described specific components of the apparatus 100, example embodiments are described below.

### EXAMPLE OPERATIONS

Turning to FIG. 2, an example flowchart is illustrated that contains example operations implemented by various embodiments contemplated herein. The operations illustrated in FIG. 2 may, for example, be performed by an apparatus 100, which is shown and described in connection with FIG. 1. To perform the operations described below, the apparatus 100 may utilize one or more of processor 102, memory 104, communications circuitry 106, input-output circuitry 108, other components, and/or any combination thereof. It will be understood that user interaction with the apparatus 100 may occur directly via input-output circuitry 108, or may instead be facilitated by a device that in turn interacts with apparatus 100.

As shown by operation 202, the apparatus 100 includes means, such as memory 104, communications circuitry 106, input-output circuitry 108, or the like, for receiving a document comprising a set of RFPs. The set of RFPs may be received from memory 104 after having previously been stored, thereby providing one mechanism for asynchronous generation of responses to the set of RFPs. Alternatively, the set of RFPs may be received via communications circuitry 106 from a separate device, thereby permitting generation of responses to the set of RFPs in near-real time with receipt of the set of RFPs. As yet another alternative, the set of RFPs may be received from a user or user device (e.g., USB key or other portable storage device controlled by the user) via input-output circuitry 108, thereby enabling the apparatus 100 to function in an on-demand service model. In some embodiments, the set of RFPs may be received by communications circuitry 106 or input-output circuitry 108 and then stored in memory 104 for subsequent utilization.

As shown by operation 204, the apparatus 100 includes means, such as processor 102, or the like, for extracting the set of RFPs from the document. As noted previously, each set of RFPs may typically include tens to hundreds of separate requests, each of which must be individually addressed in an overall response. To extract the set of RFPs from the document, the processor 102 may employ a parser that extracts text from document, and may thereafter detect relevant sections of the document that are likely to contain RFPs. The processor 102 may detect these relevant sections based on the identification of terminology known to indicate the beginning or end of the section within the document likely to be associated with requests. The processor 102 may further detect individual RFPs from within these relevant sections based on the identification of characteristics known to indicate the beginning or end of individual RFPs, including without limitation numbering, headings, paragraph formatting, and punctuation. If the document is received in a format that is not text-searchable, the processor may pre-process the document using an optical character recognition (OCR) tool to produce a text-searchable version of the document for use as indicated herein. As one example implementation for extracting a set of RFPs from a document, the processor 102 may (i) parse the document into discrete components, (ii) identify characteristics in the discrete components known to indicate the beginning or end of individual RFPs, (iii) detect the separate, individual requests within the document based on the identified characteristics, and (iv) extract these separate, individual requests as the set of RFPs.

In some embodiments, if the processor 102 is unable to detect the relevant sections based on the identification of terminology known to indicate the beginning or end of the section within the document likely to be associated with requests and/or detect each individual RFP from within these relevant sections based on the identification of characteristics known to indicate the beginning or end of individual RFPs, the apparatus 100 may transmit a notification (e.g., on a display of a computing device using communications circuitry 106 and/or input-output circuitry 108) with instructions for the user to resubmit the document after checking and/or updating the formatting of the document. The notification may also include suggestion for the user to update the formatting of the documents (e.g., include one or more example formats for the user to use).

In some embodiments, the apparatus 100 may output (e.g., on a display of a computing device using communications circuitry 106 and/or input-output circuitry 108) the detected RFPs and/or sets of RFPs to the user. The user may then interact with the apparatus (e.g., using input-output circuitry 108 of the apparatus 100) to correct any detection and/or parsing errors in each individual RFP presented to the user. For example, as part of the correction, the user may supplement additional information about each RFP (or set of RFPs) including: a set number, the name of the requesting party, the name of the responding party, or the like.

In some embodiments, in connection with (before or after) the successful identification of a set of RFPs (e.g., by apparatus 100), apparatus 100 may instruct the user (e.g., via a graphical user interface (GUI) displayed to the user on a display) to enter information (e.g., a set number for the RFP set, name(s) of the requesting party (or parties), and name(s) of the responding party (or parties), court and case number, party information including names of the plaintiff(s) and defendant(s), or the like) that may be used to identify (e.g., describe, label, etc.) the RFP set. The information used to identify the RFP set that is entered by the user may be stored in one or more data fields that will be associated with the RFP, and the information stored in these data fields (e.g., name(s) of the requesting or responding party (or parties), or the like) may be used in subsequent operations described below.

In some embodiments, apparatus 100 may also instruct the user to enter and/or edit any standard language to be used for referring to and incorporating objections (e.g., standard/template objections discussed in more detail below in reference to operation 206). For example, a user may enter “refer and incorporate general objections” as the standard language and this standard language may be used at the start of every response to every request included in the identified set of RFPs.

In some embodiments, apparatus 100 may also use tags or field identifiers (e.g., “{client}”) as placeholder for one or more terms and/or information. More specifically, each tag or field identifier may be associated with some or all of the information used to identify the RFP set. For example, the tag “{client}” may be used as a placeholder for the name(s) of the responding party (or parties) and may be automatically replaced (e.g., by apparatus 100) with the name(s) of the responding party (or parties) provided by the user when the apparatus 100 detects the use of such tags or field identifiers.

In some embodiments, apparatus 100 may also provide the user (e.g., via the GUI) options for editing the text of the RFPs as identified by the parser. This may include modifying the text of an RFP, separating (e.g., splitting) an identified RFP into multiple RFPs, combining multiple identified RFPs into a single RFP, causing the renumbering of the RFPs as detected by the parser, and the like. In some embodiments, the user may also be presented with the option (e.g., by the apparatus via the 100) to add, delete, and/or modify some or all of the information (e.g., a set number for the RFP set, name(s) of the requesting party (or parties), and name(s) of the responding party (or parties), court and case number, party information including names of the plaintiff(s) and defendant(s), or the like) each of the subset of RFPs.

As shown by operation 206, the apparatus 100 includes means, such as memory 104, communications circuitry 106, input-output circuitry 108, or the like, for generating and/or receiving a response catalog defining a set of template objections and responses. The response catalog may in some implementations be generated by the processor 102 and immediately used. The response catalog may alternatively be generated (by the apparatus 100 or otherwise) and then stored locally by the apparatus 100 to permit on-demand utilization. Alternatively, the response catalog may be received via communications circuitry 106 from a separate device or via input-output circuitry 108 from a user (e.g., via entry by the user using the GUI provided by apparatus 100), thereby enabling the apparatus 100 to deploy a response catalog provided by a user or third party. More specifically, the GUI may have an option (e.g., a button, a clickable link, or the like) for the user to input (e.g., retrieve) a response catalog stored on a computing device on which the GUI is being presented and/or from an external source (e.g., transferred to the user from another user account, stored on a USB, stored on a network drive, or the like). In some embodiments, the response catalog may be received by communications circuitry 106 or input-output circuitry 108 and stored in memory 104 for subsequent utilization.

In some embodiments, the GUI may also include an option (e.g., an “Add Catalog” button or the like) for the user to create a response catalog from scratch. When a response catalog is being created from scratch, apparatus 100 may provide the user (e.g., through the GUI) options for adding one or more objections (e.g., via an “Add Objection” button or “Add Response” button or the like). Upon selecting the “Add Objection” or “Add Response” option, the user may be prompted to: (i) enter a label for the objection; (ii) enter a full sentence text (e.g., including one or more of the above-discussed tags or field identifiers that will be able to automatically retrieve information to replace the tag in the actual objection to be displayed and/or to permit the user to provide instance-specific user-defined text (e.g., through the use of a “{blank}” tag that will trigger apparatus 100 to prompt the user to enter custom text (e.g. user-defined text) in the location of the “{blank}” tag through the GUI (e.g., via a pop-up window or the like) when the Objection or Response is selected as part of a response to a specific RFP) to be inserted in a content field of the newly added objection. The user may repeat this process of adding new objections as necessary for all template objections that the user wishes to use for responding to one or more sets of RFPs. In some embodiments, rather than filling in the contents of a new objection from scratch each time the user wishes to add an objection, apparatus 100 may provide (e.g., via the GUI) an option for cloning (e.g., copying the entire contents of) an existing objection that the user has already entered/added. The apparatus 100 may also provide (e.g., via the GUI) an option for the user to edit and/or delete each newly added (or cloned) objections.

In some embodiments, similar to the creation and addition of objections, apparatus 100 may provide the user (e.g., through the GUI) with options for creating and adding responses to be used (e.g., included) in the response catalog. In particular, each response may be added, edited, and/or deleted in the same method described above for adding, editing, and/or deleting objections.

In some embodiments, deletion of an existing objection may remove the objection from the active response catalog in which the objection was created. However, the deleted objection may still be retained (e.g., by apparatus 100) in a database (e.g., a database configured in memory 104) such that any set of objections and responses (discussed in more detail below in operation 208) previously generated using the deleted objection will not produce any errors (e.g., error of not being able to find and/or retrieve from the database an existing objection or the like).

In some embodiments, whenever a response catalog is retrieved or added, the GUI may instruct the user to provide a name for the added and/or retrieved response catalog.

In some embodiments, apparatus 100 may also provide the user (e.g., via the GUI) options for editing, copying, sharing, and/or deleting one or more response catalogs. More specifically, editing allows the user to make one or more edits to one or more existing response catalogs. Copying allows the user to make a copy of an existing response catalog (e.g., in order to create multiple versions of a specific response catalog to reflect preferences of different clients). Sharing allows the user to send a copy of one or more selected response catalogs to another user (e.g., via copying the response catalog to the recipient user's account, and providing a notification and/or option whether to accept the transfer via email notification or the like) where each user account will thereafter have a discrete copy of the response catalog, such that subsequent edits by one user of a shared response catalog will not affect the other user's copy of the response catalog). In still further embodiments, a user may grant one or more other users access to a common, shared response catalog, such that the identified users may individually or collectively modify and access the same response catalog. Deleting allows the user to remove the response catalog from the list of response catalogs shown on the GUI.

As shown by operation 208, the apparatus 100 includes means, such as processor 102, or the like, for interactively preparing a set of objections and responses using the set of separate requests and the response catalog. As described therein, the apparatus 100 may display, to the user, (e.g., via the GUI) various information regarding each of the requests, and may permit the selection of template objections or responses from the response catalog. The templates contained in the response catalog may, in this regard, be usable in connection with dynamic content, such that selection of a template response or template objection may cause pre-population of the template language in combination with case-specific information retrieved via the dynamic componentry. Preparation of a set of objections and responses may include introducing revisions into the response catalog, which is illustrated by the dotted line returning from operation 208 back to operation 206,

In some embodiments, as part of the responding to one or more sets of RFPs, a user may first select (e.g., on the GUI) one or more sets of RFPs corresponding to a case that the user is presently handling. For example, upon selection of the set(s) of RFPs, the user may be provided with a “respond” button/option on the GUI. After the user clicks on the “respond” button, apparatus 100 may display (e.g., one-by-one on the GUI) the text of each RFP within the selected set(s) of RFPs along with a checklist of objections and responses stored in one or more response catalogs. In some embodiments, the user may select (e.g., via the GUI) a specific response catalog the user wishes to use to respond to the RFPs in the selected set(s) of RFPs.

In some embodiments, upon displaying the text of each RFP to the user, apparatus 100 may allow the user (e.g., via the GUI) to manually edit contents (e.g., the text, the request number, or the like) of the RFP should the content of the RFP be incorrect (e.g., as a result of incorrect detection by the parser in above-discussed operation 204).

In some embodiments, the user may be prompted (e.g., by apparatus 100 via the GUI) to select all applicable objections (e.g., from the checklist of objections and responses displayed on the GUI) that apply to the RFP being displayed. In this instance, if a user selects an objection that includes a tag showing “{blank}”, apparatus 100 will prompt the user to enter custom text for that request in the location of the “{blank}” tag via a pop-up on the GUI. Similar to the selection of objections, in some embodiments, the user may also be prompted (e.g., by apparatus 100 via the GUI) to select a response (e.g., from the checklist of objections and responses displayed on the GUI) that apply to the RFP being displayed. When the user is satisfied with his/her selection of objection(s) and response for the RFP being displayed, the user may instruct apparatus 100 (e.g., via selection of a “next” button on the GUI) to display the next RFP in the set(s) of RFPs previously selected by the user. Additionally, apparatus 100 may also provide an option (e.g., via a drop-down menu or the like) on the GUI for the use to see and navigate through all of the individual requests in the set(s) of RFPs selected by the user. Once all requests within the set(s) of RFPs have been addressed, the user may end the interactive process by clicking a “Done” button (or the like) on the GUI to indicate that the user has completed his/her response to the selected set(s) of RFPs. In still further embodiments, a user may grant one or more other users access to a common, shared set of responses to the RFP, such that the identified users may individually or collectively modify and access the set of responses.

As shown by operation 210, the apparatus 100 includes means, such as processor 102, or the like, for generating a formatted document including the set of objections and responses, the formatted document comprising a set of responses to the set of RFPs. For example, the user may instruct apparatus 100 (e.g., via a “Generate” button on the GUI or the like) to generate the formatted document for each set of RFPs for which the user has completed his/her responses to the RFPs included within the set of RFPs. The formatted document may be generated from structured text created during generation of the set of objections and responses. In some embodiments the formatted document may be generated in any format (e.g., a MS Word document, an RTF document, a PDF, or the like). In some embodiments, in an instance where a MS Word document is generated, the contents of the MS Word document may be generated as having, but is not limited to, 12-point, single-spaced, Times New Roman font. In some embodiments, the formatted document may be saved to any destination (e.g., the same computing device on which apparatus 100 is operating, an external storage device such as a USB key or a remote network drive, or the like) specified by the user (e.g., via the GUI).

As shown by operation 212, the apparatus 100 includes means, such as memory 104, communications circuitry 106, input-output circuitry 108, or the like, for outputting the formatted document. In this regard, the formatted document may be stored by the apparatus in memory 104, thereby permitting retention of the formatted document for subsequent utilization. Alternatively, the response catalog may be delivered via communications circuitry 106 to a separate device or delivered via input-output circuitry 108 to a user (or user device such as a USB key), thereby enabling the apparatus 100 to provide the results of the enhanced document generation process for consumption by a user or third party.

In some scenarios, the formatted document may be displayed via a user interface (e.g., input-output circuitry 108), which may cause or permit an individual to determine that revisions are necessary to the formatted document. In such situations, the procedure may return from operation 212 back to operation 208, for generation of a new or revised set of objections and responses, which thereafter leads the procedure back to operation 210 for generation of a revised formatted document, and to operation 212 for outputting of the revised formatted document. This iterative process may be repeated as-needed until the formatted document is deemed to be in suitable condition for its designated purpose. Furthermore, display of the formatted document via a user interface may cause or permit an individual to determine that revisions are necessary to the response catalog itself, in which case the procedure may return from operation 212 back to operation 206 to enable a new or revised response catalog to be generated and/or received, and then used to re-create the formatted document.

Additional permutations of the procedure set forth in connection with FIG. 2 are contemplated herein as well. For instance, although an on-premises implementation may be the most obvious implementation, cloud-based implementations are also contemplated, thereby facilitating a scalable cloud-based Software-as-a-Service (SaaS) solution for broader utilization. Similarly, although described above in connection with RFPs, other types of documents may be generated using a similar approach, such as interrogatories, requests for admission, subpoenas, protective orders, pleadings, and the like. Similarly, in various embodiments the apparatus 100 may leverage one or more jurisdiction-specific objection/response catalog modules, thereby permitting greater applicability to a variety of scenarios, as well as greater fidelity in the generation of a formatted document relating to a jurisdiction having unique local rules. Finally, certain implementations contemplated herein may utilize artificial intelligence (AI) and/or machine learning to use the corpus of data gathered from deployment of the apparatus 100 as a training dataset for AI or machine learning implementation of generating responses to RFPs.

In particular, in some embodiments where AI and/or machine learning are utilized, specifically including but not limited to automated text recognition models, apparatus 100 may (e.g., using processor 102) generate a structured database (dB) (e.g., a relatively small (e.g., compared with large language model AI systems) yet highly structured dataset) for storing the training dataset. The structured dB may be stored in memory 104 of apparatus 100. In some embodiments where AI and/or machine learning are utilized, one or more training data sets for training the AI and/or machine learning model (e.g., an AI and/or machine learning algorithm executing on apparatus 100) may be provided and stored in the structured dB. The one or more training data sets may include historical objections and response data such as, but not limited to: previous human-user-implemented selections of objections and responses, e.g., as selected from an objection/response catalog; previously generated ones of the formatted documents (that may or may not have been checked/modified by a human user); or the like. Additionally, the one or more training data sets may be provided to train the AI and/or machine learning model to obtain a trained AI and/or machine learning algorithm (also referred to herein as “a trained RFP objections and response selection model”) that may automatically select the best (e.g., based on one or more predefined objection and response selection criteria set by a user including most common, most plausible, and/or otherwise highest-scored by the trained AI and/or machine learning model) objections and response for a particular RFP within the set of RFPs. Thus, such use of a structured dB may advantageously result in a significant reduction in the necessary training data and/or computing resources for the AI and/or machine learning implementation of embodiments described herein to achieve acceptable quality results (e.g., comparable results to the human-operated scalable cloud-based SaaS solution), at a significantly greater time- and cost-savings, compared both with traditional methods of manually drafting responses to RFPs as well as with the use of embodiments disclosed herein that involve user-selection of objections and responses.

In some embodiments, the structured dB may also be separated (e.g., partitioned) into multiple storage zones including storage zones for public data and storage zones for sensitive data (e.g., data deemed and/or marked as confidential by one or more users of embodiments disclosed herein). For example, each user (e.g., customer) of embodiments disclosed herein may be partitioned a general pool (also referred to herein as a “general zone”) and a confidential business information (CBI) pool (also referred to herein as a “confidential information zone” or “confidential zone”) within the structured dB. Additionally, the one or more training data sets associated with each user of embodiments disclosed herein may also be processed such that parts of the one or more training data sets determined to be non-confidential are stored in the general zone while other parts of the one or more training data sets determined to be confidential to a specific user are stored in the confidential information zone partitioned for the specific user. In some embodiments, information stored in the general pool may be accessed by processor 102 during various stages of the draft RFP response generation process (e.g., any of operations 202-212 of FIG. 2) as AI training data in generating draft RFP responses for any users of apparatus 100 while information from the CBI pool may be accessed by processor 102 as AI training data in generating draft RPFs for the specific user (or group of users) for which the CBI pool is partitioned. In some embodiments, the storage of information into a CBI pool for a user may be initiated when the set of RFPs are extracted from a document (e.g., during a parsing of a document in operation 204 of FIG. 2) and/or during the generation and/or receipt of a response catalog from a user (e.g., in operation 206 of FIG. 2).

In some embodiments, various processes may be implemented by the processor 102 during the parsing (e.g., by the parser of the processor 102) of a document for confidential and/or sensitive information. For example, the parser may identify information (e.g., specific keywords identified by the user) within the document that is tagged as confidential and ensure that the identified confidential information is segregated in a more secure place (e.g., the CBI pool within the structured dB). The tagging of the confidential information may be done at any time and by any entity (e.g., an owner of the document and/or a computer) prior to the document being provided to apparatus 200 in operation 202 of FIG. 2. As another example, individual requests and/or one or more sets of requests within a document may be tagged as confidential and moved or stored (e.g., segregated) to the CBI pool after being identified by the parser. Such segregation of CBI advantageously allows embodiments disclosed herein to be trained using data from all users of apparatus 100 while still protecting each user's confidential and sensitive data. In some embodiments utilizing an AI and/or machine learning implementation, only non-confidential data in the general pool (or “general zone”) may be used as training data according to the implementation described above. In other embodiments utilizing an AI and/or machine learning implementation, both confidential and non-confidential data may be used as training data.

FIG. 2 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for enhanced automated document generation, the method comprising:
receiving, by an apparatus, a document comprising a set of requests for production (RFPs);
extracting, by the apparatus, the set of RFPs from the document;
receiving, by the apparatus, a response catalog defining a set of template objections and responses;
interactively preparing, by the apparatus, a set of objections and responses to the individual RFPs using the set of RFPs and the response catalog; and
generating, by the apparatus, a formatted document including the set of objections and responses, the formatted document comprising a set of responses to the set of RFPs.

2. The method of claim 1, wherein the document comprising the set of RFPs is received during a litigation discovery period and the formatted document is generated in response to a request for production received during the litigation discovery period.

3. The method of claim 1, further comprising:
generating, by the apparatus, revisions to the set of objections and responses;
re-generating, by the apparatus, a revised formatted document, the revised formatted document comprising a revised set of responses to the set of RFPs; and
outputting, by the apparatus, the revised formatted document.

4. The method of claim 1, wherein interactively preparing the set of objections and responses further comprises:
training, by the apparatus, an artificial intelligence or machine learning model using a training data set to obtain a trained RFP objections and response selection model, wherein the training data set comprises historical objections and response data; and
automatically selecting, by the apparatus and using the trained RFP objections and response selection model, the set of objections and responses to the individual RFPs based on one or more predefined objection and response selection criteria.

5. The method of claim 1, further comprising:
generating, by the apparatus, a structured database (dB); and
storing, by the apparatus, the set of RFPs extracted from the document, the response catalog, and information associated with the preparation of the set of objections and responses using the set of RFPs and the response catalog into the structured dB.

6. The method of claim 5, wherein generating the structured dB further comprises partitioning, by the apparatus, the structured dB into a general zone and confidential information zone.

7. The method of claim 6, further comprising:
parsing, by the apparatus and while extracting the set of RFPs from the document, the document for sensitive or confidential information; and
segregating, by the apparatus, the sensitive or confidential information from remaining information in the document by storing the sensitive or confidential information in the confidential zone of the structured dB and the remaining information in the general zone of the structured dB.

8. The method of claim 7, wherein interactively preparing the set of objections and responses further comprises:
training, by the apparatus, an artificial intelligence or machine learning model using a training data set to obtain a trained RFP objections and response selection model, wherein the training data set comprises historical objections and response data compiled from information stored in at least one of the general zone or the confidential information zone; and
automatically selecting, by the apparatus and using the trained RFP objections and response selection model, the set of objections and responses to the individual RFPs based on one or more predefined objection and response selection criteria.

9. An apparatus for automated enhanced document generation, the apparatus comprising a processor and a memory storing software instructions that, when executed by the processor, cause the apparatus to:
receive a document comprising a set of requests for production (RFPs);
extract the set of RFPs from the document;
receive a response catalog defining a set of template objections and responses for the set of RPFs;
interactively prepare a set of objections and responses using the set of RFPs and the response catalog; and
generate a formatted document including the set of objections and responses, the formatted document comprising a set of responses to the set of RFPs.

10. The apparatus of claim 9, wherein the document comprising the set of RFPs is received during a litigation discovery period and the formatted document is generated in response to a request for production received during the litigation discovery period.

11. The apparatus of claim 9, wherein the apparatus is further caused to:
generate revisions to the set of objections and responses;
re-generate a revised formatted document, the revised formatted document comprising a revised set of responses to the set of RFPs; and
output the revised formatted document.

12. The apparatus of claim 9, wherein interactively preparing the set of objections and responses further comprises, by the apparatus:
training an artificial intelligence or machine learning model using a training data set to obtain a trained RFP objections and response selection model, wherein the training data set comprises historical objections and response data; and
automatically selecting, by the apparatus and using the trained RFP objections and response selection model, the set of objections and responses to the individual RFPs based on one or more predefined objection and response selection criteria.

13. The apparatus of claim 9, wherein the apparatus is further caused to:
generate a structured database (dB); and
store the set of RFPs extracted from the document, the response catalog, and information associated with the preparation of the set of objections and responses using the set of RFPs and the response catalog into the structured dB.

14. The apparatus of claim 13, wherein the apparatus is further caused to, as part of generating the structured dB:
partition the structured dB into a general zone and confidential information zone.

15. The apparatus of claim 14, wherein the apparatus is further caused to:
parse, while extracting the set of RFPs from the document, the document for sensitive or confidential information; and
segregate the sensitive or confidential information from remaining information in the document by storing the sensitive or confidential information in the confidential zone of the structured dB and the remaining information in the general zone of the structured dB.

16. The apparatus of claim 15, wherein interactively preparing the set of objections and responses further comprises, by the apparatus:
training an artificial intelligence or machine learning model using a training data set to obtain a trained RFP objections and response selection model, wherein the training data set comprises historical objections and response data compiled from information stored in at least one of the general zone or the confidential information zone; and
automatically selecting, by the apparatus and using the trained RFP objections and response selection model, the set of objections and responses to the individual RFPs based on one or more predefined objection and response selection criteria.

17. A computer program product for automated enhanced document generation, the computer program product comprising at least one non-transitory computer-readable storage medium storing software instructions that, when executed, cause an apparatus to:
receive a document comprising a set of requests for production (RFPs);
extract the set of RFPs from the document;
receive a response catalog defining a set of template objections and responses;
interactively prepare a set of objections and responses using the set of RFPs and the response catalog; and
generate, by the apparatus, a formatted document including the set of objections and responses, the formatted document comprising a set of responses to the set of RFPs.

18. The computer program product of claim 17, wherein the document comprising the set of RFPs is received during a litigation discovery period and the formatted document is generated in response to a request for production received during the litigation discovery period.

19. The computer program product of claim 17, wherein the apparatus is further caused to:
generate revisions to the set of objections and responses;
re-generate a revised formatted document, the revised formatted document comprising a revised set of responses to the set of RFPs; and
output the revised formatted document.

20. The computer program product of claim 17, wherein interactively preparing the set of objections and responses further comprises:
training an artificial intelligence or machine learning model using a training data set to obtain a trained RFP objections and response selection model, wherein the training data set comprises historical objections and response data; and
automatically selecting, by the apparatus and using the trained RFP objections and response selection model, the set of objections and responses to the individual RFPs based on one or more predefined objection and response selection criteria.

21. The computer program product of claim 17, wherein the apparatus is further caused to:
generate a structured database (dB); and
store the set of RFPs extracted from the document, the response catalog, and information associated with the preparation of the set of objections and responses using the set of RFPs and the response catalog into the structured dB.

22. The computer program product of claim 21, wherein the apparatus is further caused to, as part of generating the structured dB:
partition the structured dB into a general zone and confidential information zone.

23. The computer program product of claim 22, wherein the apparatus is further caused to:
parse, while extracting the set of RFPs from the document, the document for sensitive or confidential information; and
segregate the sensitive or confidential information from remaining information in the document by storing the sensitive or confidential information in the confidential zone of the structured dB and the remaining information in the general zone of the structured dB.

24. The computer program product of claim 23, wherein interactively preparing the set of objections and responses further comprises:
training an artificial intelligence or machine learning model using a training data set to obtain a trained RFP objections and response selection model, wherein the training data set comprises historical objections and response data compiled from information stored in at least one of the general zone or the confidential information zone; and
automatically selecting, by the apparatus and using the trained RFP objections and response selection model, the set of objections and responses to the individual RFPs based on one or more predefined objection and response selection criteria.
